(19) United States
(12) Patent Application Publication
(10) Pub. No.: US 2026/0286081 A1
(43) Pub. Date: Sep. 24, 2026

(54) CELLULOSE ESTER COMPOSITIONS WITH FLOW AID

(71) Applicant: Eastman Chemical Company, Kingsport, TN (US)

(72) Inventors: Stephanie Kay Clendennen, Kingsport, TN (US); Rahul Shankar, Kingsport, TN (US); Hamid Ebrahimi, Kingsport, TN (US); Kimberley Carmenia Carico, Kingsport, TN (US); Jeffrey Michael Clauson, Kingsport, TN (US); Monika Karin Wiedmann Boggs, Kingsport, TN (US)

(73) Assignee: Eastman Chemical Company, Kingsport, TN (US)

(21) Appl. No.: 19/474,301

(22) PCT Filed: Apr. 8, 2024
(86) PCT No.: PCT/US2024/023543

§ 371 Date: Oct. 10, 2025

Related U.S. Application Data
(60) Provisional application No. 63/495,375, filed on Apr. 11, 2023.

(51) Int. Cl. C08J 9/14; C08J 5/18; C08J 9/00; C08K 5/092; C08K 5/098; C08K 5/103

(52) U.S. Cl. CPC C08J 9/142; C08J 5/18; C08J 9/0023; C08J 9/0052; C08K 5/092; C08K 5/098; C08K 5/103; C08J 2301/12

(57) ABSTRACT

A melt-processable cellulose ester formulation is described that includes an ionic flow aid to enable reduced plasticizer content and increase heated dimensional stability. One or more stabilizers may also be included in the formulations. The formulations are particularly suitable for melt-processing applications, such as extrusion, and may be formed into useful articles.

### BACKGROUND OF THE INVENTION

There is a need for a bio-based or biodegradable material that has physical properties that can compete with traditional plastics in a range of applications. Cellulose acetate (CA) is a bio-based and biodegradable resin, and compositions have been used for a variety of melt-processed articles. Cellulose acetate compositions used in melt processing and forming of articles typically contain significant amounts of plasticizer to allow for processing and to impart toughness to the molded article. However, the addition of plasticizer has drawbacks, as it will decrease the Heated dimensional stability relative to the base cellulose ester. If the plasticized CA composition does not effectively exclude moisture uptake, then water in the article will act as a plasticizer and further lower the Heated dimensional stability. CA compositions with low heat deflection temperature (HDT) and high moisture uptake exclude use of the cellulose ester materials from applications that expose formed articles to heat, moisture and especially a combination of heat and moisture.

There are many different plasticizers for cellulose acetate. For example, Triacetin is an efficient plasticizer for cellulose acetate, and its bio-based and non-toxic profile makes it a good candidate for applications in which it will contact food, such as single use foodservice items. However, many plasticizers, including Triacetin are fairly polar, and allow for significant moisture uptake of the compounded cellulose acetate, resulting in a reduction in the HDT. It is possible to add hydrophobic additives to cellulose acetate that leads to low moisture absorption and high HDT values even at high humidity levels. It is also possible to reduce the plasticizer level to increase the stiffness of an article. But melt flow is reduced at low plasticizer loading, leading to pressure build-up during processing or to increasing the melt temperatures increasing the risk of thermal degradation.

### SUMMARY OF THE INVENTION

The addition of a flow aid to the compositions permits the melt processing of cellulose esters, such as cellulose acetate, at lower loadings of plasticizer. In one embodiment or in combination with any other embodiment mentioned herein, the addition of salts of fatty acids, plus optional stabilizers, results in a formulation that increase the heated dimensional stability of formed articles. The fatty acid salts may function to enhance melt flow and to inhibit water from plasticizing the article. The benefit of fatty acid salts is that they are substantially less volatile than fatty acids, which can volatilize during melt processing and re-condense on equipment to cause fouling or in the air to form an inhalation irritation. Fatty acid salts may be more compatible with cellulose acetate than many fatty acid esters, like triglycerides, diglycerides and monoglycerides, which may exude or bloom on the surface.

In one embodiment or in combination with any other embodiment mentioned herein, there is provided a composition comprising: a) a cellulose ester; b) a plasticizer; and c) a flow aid comprising a salt having a melting point of 100° C. to 250° C.

In another embodiment or in combination with any other embodiment mentioned herein, there is provided a composition comprising: a) a cellulose ester; b) a plasticizer; and c) greater than 0.3% by weight of a flow aid.

In another embodiment or in combination with any other embodiment mentioned herein, there is provided a composition comprising: a) a cellulose ester; b) a plasticizer; c) a flow aid; and d) a carboxylic acid stabilizer.

In another embodiment or in combination with any other embodiment mentioned herein, there is provided a composition comprising: a) a cellulose ester; b) a plasticizer; and c) a flow aid comprising a blend of metal fatty acid salts.

In another embodiment or in combination with any other embodiment mentioned herein, there is provided a composition comprising: a) a cellulose ester; b) a plasticizer; and c) a flow aid comprising a magnesium fatty acid salt.

In another embodiment or in combination with any other embodiment mentioned herein, there is provided a composition comprising: a) a cellulose ester; b) a plasticizer; and c) a flow aid. The composition has a heat deflection temperature of greater than 50° C. when tested under low pressure at 100% relative humidity (RH) according to ASTM D648, ISO 75.

### BRIEF DESCRIPTION OF THE DRAWINGS

Figure (FIG. 1 is a schematic diagram illustrating a bio-based article forming process according to embodiments of the present invention; and

FIG. 2 is a schematic diagram illustrating another biobased article forming process according to embodiments of the present invention.

### DETAILED DESCRIPTION

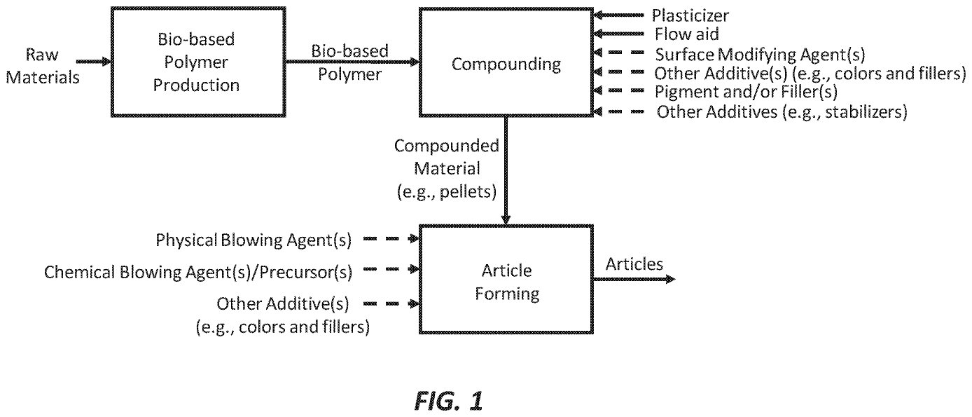

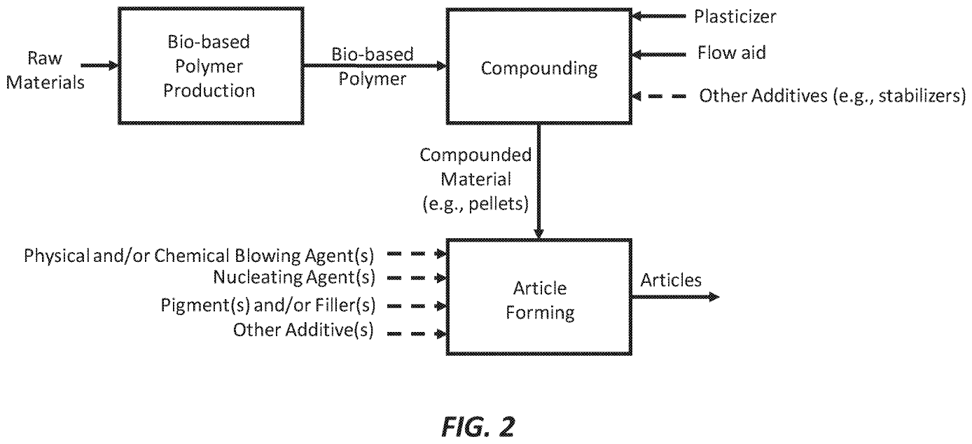

Embodiments are generally directed to methods, systems, and compositions for forming bio-based particulate materials (e.g., pellets), sheets, and articles. Exemplary processes including the methods, systems, and compositions are depicted in FIGS. 1-2 and are described in greater detail below.

### Methods and Systems

As shown in FIG. 1 and FIG. 2, raw materials may be introduced to a bio-based polymer production process, which produces a bio-based polymer material. As used herein, the term “bio-based” refers to a polymer material composed in whole, or in significant part of, biological products or renewable agriculture materials. In one embodiment or in combination with any other embodiment mentioned herein, the bio-based polymer material comprises one or more cellulose esters. The one or more cellulose esters may comprise cellulose acetates. In such embodiments, the raw materials may comprise a pulp, such as wood pulp and/or cotton pulp. The pulp may be a dissolving-grade pulp and/or a paper-grade pulp. The cellulose in the pulp may be esterified, for example with an acetic acid, to form the bio-based cellulose ester polymer, such as a cellulose acetate polymer.

The bio-based polymer material may then be introduced into a compounding process, in which the bio-based polymer material may be mixed with plasticizer and a flow aid, and optionally one or more other additives (e.g., stabilizers), and formed into a compounded material comprising a plasticized bio-based polymer. One or more other additives may also be mixed with the polymer, plasticizer, and flow aid. For example, as shown in FIG. 1, the other materials (additives) may include, but are not limited to, stabilizers, physical blowing agent(s), chemical blowing agent(s) (and/or precursors), nucleating agent(s), surface modifying additive(s), pigment(s), filler(s), and/or other additive(s). Mixing can be accomplished by any known mixing technique, including, but not limited to, rolling in a cylindrical container, overhead stirring, sigma blade mixing, and tumbling.

The compounding process may include a particulating process. The particulating process may generally comprise mixing the bio-based polymer material, plasticizer, flow aid, and optionally other additive(s) to form a mixed composition and forming particulate material from the composition. In particular, the particulating process may include a pelletization process, and the particulate material may comprise a quantity of pellets. The term “compounded CE material” means cellulose ester material formed during the compounding process, which may include a mixture of cellulose ester, plasticizer, flow aid, and optionally other additives. Further such compounded CE material may be in the form of particulate material or pellets. It should be understood that, as used herein, the phrases “particulating” or “particulating processes” may be the same as, or may at least include, “pelletizing” or “pelletizing processes.” In some embodiments, the particulating process may include pelletizing into a water bath, pelletizing on an air-cooled belt, underwater pelletizing, solvent compounding, etc.

In one embodiment or in combination with any other embodiment mentioned herein, the plasticizer, flow aid, and other additive(s) may be mixed with cellulose esters by conventional melt compounding techniques, which involve combining the cellulose ester with the plasticizer and the flow aid, and optionally the other additives, in a twin screw extruder with appropriate mixing elements and at appropriate temperatures and pressures to achieve a molten, homogeneously combined, cellulose ester mixture by the time the materials exit the extruder. The molten, compounded, cellulose ester mixture may then be extruded through a die with orifices that are about 2-6 mm in diameter so as to extrude a strand. This strand may then be cooled by water (e.g., via underwater pelletization) or air and cut at regular intervals to provide a uniform and desirable size and shape, referred to as “pellets” or “granules.” Although a process for forming pelletized compounded material is described herein, it will be understood that the compounded material fed to the article forming process can be in any physical shape (e.g., pellets, powders, granules, fibers) in accordance with some embodiments. Further such compounded material may be in the form of a molten mixture or a particulate material (e.g., pellets, powders, granules, fibers, etc.)

The compounded material, which as noted above may comprise pellets of plasticized bio-based polymer, may then be introduced into an article forming process, as illustrated in FIGS. 1 and 2. In one embodiment or in combination with any other embodiment mentioned herein, the article forming process comprises a sheet production process. The sheet production process may comprise a foam sheet production process. The sheet production process may include one or more zones/steps for producing a sheet or film, which are described in greater detail below.

The article forming process may be used to produce foamed materials and articles or rigid (i.e., non-foamed) materials and articles. As shown in FIG. 2, in one embodiment or in combination with any other embodiment mentioned herein, various additives may be introduced to one or more zones of the article forming process. The article forming process may include an extrusion section, a sheet forming section, and/or a thermoforming section.

In one embodiment or in combination with any other embodiment mentioned herein, the article forming process may comprise introducing the compounded material to a heated mixing zone to form a CE melt composition. The heated mixing zone may include, but is not limited to, an internal mixer (e.g., a static mixer), a roll mill, a kneader, and/or an extrusion process. Other heated mixing processes may also be used. The extrusion process may comprise one or more extruders, which may include single screw and/or twin screw extruders. Within the extruder(s), the compounded CE composition may be introduced into an extruder barrel and conveyed, via the screw(s), through a die, which forms an extrudate from the feed composition. The composition may be heated, and at least partially melted, as it is conveyed through the extruder barrel toward the die. Thus, the term “CE melt composition” is used herein to mean the cellulose ester-based feed composition that has been melted into a flowable, molten resin via the heated mixing zone. Heating may be supplied by external heaters positioned along the outside of the extruder barrel. The shape of the extrudate will generally depend on the shape and size of the die head. The extrudate may be further shaped by downstream processes, such as forming mandrels and/or thermoforming processes.

One or more additive(s) may be introduced to the CE melt resin while in the article forming process, such as in the heated mixing zone. For example, one or more physical blowing agent(s) may be added to the CE melt resin by injecting the physical blowing agent into the composition being conveyed within the extruder barrel. Other components such as plasticizer and flow aid may also be introduced in the heated mixing zone. When the heated mixing zone comprises an extruder, the CE melt resin may then be directed through an extrusion die to provide a cellulose ester-based extrudate, which may be further processed to form a CE sheet or article. Although an extrusion process is generally described above, it should be understood that the article forming process may comprise one or more other additional or alternative processes for producing an article from the CE melt resin. Such processes may include, but are not limited to, profile extrusion, injection molding, thermoforming, injection blow molding, rotational molding, and melt spinning.

Referring again to FIG. 1 and FIG. 2, the compositions described herein may be used to produce cellulose ester sheets and articles. The articles may have one or more particularly advantageous properties. For example, the articles may be biodegradable and/or compostable, and/or the articles may have superior mechanical properties (e.g., strength, density, cell size, absorption, etc.).

### Compositions

The processes described above may comprise the preparation and processing of compositions that may be used for downstream processing to form useful articles. For example, in one embodiment or in combination with any other embodiment mentioned herein, the article forming process feed material may comprise a particulate material comprising a bio-based polymer, a plasticizer, flow aid, and optionally one or more additive(s), such as those described herein. In one embodiment or in combination with any other embodiment mentioned herein, the feed material may be combined with one or more additive(s), such as those described herein, to provide a mixed composition comprising the bio-based polymer, the plasticizer, the flow aid and the one or more additive(s). In one embodiment or in combination with any other embodiment mentioned herein, the bio-based polymer comprises cellulose ester. Additional details of the composition components, including bio-based polymers (e.g., cellulose esters), plasticizers, flow aids, optional stabilizers, and other optional additives, are provided below.

Although some exemplary components described below may be described under more than one category, it should be understood that these are intended to be included as separate components. For example, although magnesium stearate is described as a flow aid and an optional surface modifying additive or inorganic physical nucleating agent, magnesium stearate may be included separately or added to the composition at different times and/or amounts to serve different functions in the composition.

It should be further understood that the compositions according to embodiments of the present invention may include or omit certain components described herein, as suitable for the particular application. Other components not described herein may also be included without departing from the scope of the invention. However, in one embodiment or in combination with any other embodiment, the composition may not comprise, comprises less than 1% by weight, or comprises less than 0.1% by weight, of a polyester-based additive having a polybasic acid and a polyhydric alcohol.

### Cellulose Ester

The cellulose esters utilized as described herein can be any that is known in the art. Cellulose ester that can be used for embodiments herein generally comprise repeating units of the structure:

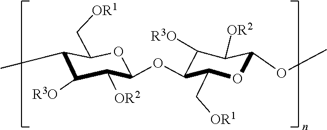

wherein R¹, R², and R³ are selected independently from the group consisting of hydrogen acetyl, propyl or butyl. The substitution level of the cellulose ester is usually expressed in terms of degree of substitution (DS), which is the average number of non-OH substituents per anhydroglucose unit (AGU). Generally, conventional cellulose contains three hydroxyl groups in each AGU unit that can be substituted; therefore, DS can have a value between zero and three. Native cellulose is a large polysaccharide with a degree of polymerization from 250-5,000 even after pulping and purification, and thus the assumption that the maximum DS is 3.0 is approximately correct. Because DS is a statistical mean value, a value of 1 does not assure that every AGU has a single substituent. In some cases, there can be unsubstituted anhydroglucose units, some with two and some with three substituents, and typically the value will be a non-integer. Total DS is defined as the average number of all of substituents per anhydroglucose unit. The degree of substitution per AGU can also refer to a particular substituent, such as, for example, hydroxyl or acetyl. In one embodiment or in combination with any other embodiment, n is an integer in a range from 25 to 250, or 25 to 200, or 25 to 150, or 25 to 100, or 25 to 75.

In one embodiment or in combination with any other embodiment, the cellulose esters have at least 2 anhydroglucose rings and can have between at least 50 and up to 5,000 anhydroglucose rings, or at least 50 and less than 150 anhydroglucose rings. The number of anhydroglucose units per molecule is defined as the degree of polymerization (DP) of the cellulose ester. In one embodiment or in combination with any other embodiment, cellulose esters can have an inherent viscosity (IV) of about 0.2 to about 3.0 deciliters/gram, or about 0.5 to about 1.8, or about 1 to about 1.5, as measured at a temperature of 25° C. for a 0.25 gram sample in 100 ml of a 60/40 by weight solution of phenol/tetrachloroethane. In one embodiment or in combination with any other embodiment, cellulose esters useful herein can have a DS/AGU of about 1 to about 3.0, of about 2.2 to about 2.8, or 1 to less than 2.2, or 1 to less than 1.5, and the substituting ester is acetyl.

Cellulose esters can be produced by any method known in the art. Examples of processes for producing cellulose esters are taught in Kirk-Othmer, Encyclopedia of Chemical Technology, 5th Edition, Vol. 5, Wiley-Interscience, New York (2004), pp. 394-444. Cellulose, the starting material for producing cellulose esters, can be obtained in different grades and sources such as from cotton linters, softwood pulp, hardwood pulp, corn fiber and other agricultural sources, and bacterial cellulose, among others.

One method of producing cellulose esters is esterification of the cellulose by mixing cellulose with the appropriate organic acids, acid anhydrides, and catalysts. Cellulose is then converted to a cellulose triester. Ester hydrolysis is then performed by adding a water-acid mixture to the cellulose triester, which can then be filtered to remove any gel particles or fibers. Water is then added to the mixture to precipitate the cellulose ester. The cellulose ester can then be washed with water to remove reaction by-products followed by dewatering and drying.

The cellulose triesters to be hydrolyzed can have three acetyl substituents. These cellulose esters can be prepared by a number of methods known to those skilled in the art. For example, cellulose esters can be prepared by heterogeneous acylation of cellulose in a mixture of carboxylic acid and anhydride in the presence of a catalyst such as H₂SO₄. Cellulose triesters can also be prepared by the homogeneous acylation of cellulose dissolved in an appropriate solvent such as LiCl/DMAc or LICl/NMP.

Those skilled in the art will understand that the commercial term of cellulose triesters also encompasses cellulose esters that are not completely substituted with acyl groups. For example, cellulose triacetate commercially available from Eastman Chemical Company, Kingsport, TN, U.S.A., typically has a DS from about 2.85 to about 2.99.

After esterification of the cellulose to the triester, part of the acyl substituents can be removed by hydrolysis or by alcoholysis to give a secondary cellulose ester. As noted previously, depending on the particular method employed, the distribution of the acyl substituents can be random or non-random. Secondary cellulose esters can also be prepared directly with no hydrolysis by using a limiting amount of acylating reagent. This process is particularly useful when the reaction is conducted in a solvent that will dissolve cellulose. All of these methods yield cellulose esters that are useful in this invention.

In one embodiment or in combination with any of the mentioned embodiments, the cellulose acetates are cellulose diacetates that have a polystyrene equivalent number average molecular weight (Mn) from about 10,000 to about 100,000 as measured by gel permeation chromatography (GPC) using NMP as solvent and polystyrene equivalent Mn according to ASTM D6474. In one embodiment or in combination with any other embodiment, the cellulose acetate composition comprises cellulose diacetate having a polystyrene equivalent number average molecular weights (Mn) from 10,000 to 90,000; or 10,000 to 80,000; or 10,000 to 70,000; or 10,000 to 60,000; or 10,000 to less than 60,000; or 10,000 to less than 55,000; or 10,000 to 50,000; or 10,000 to less than 50,000; or 10,000 to less than 45,000; or 10,000 to 40,000; or 10,000 to 30,000; or 20,000 to less than 60,000; or 20,000 to less than 55,000; or 20,000 to 50,000; or 20,000 to less than 50,000; or 20,000 to less than 45,000; or 20,000 to 40,000; or 20,000 to 35,000; or 20,000 to 30,000; or 30,000 to less than 60,000; or 30,000 to less than 55,000; or 30,000 to 50,000; or 30,000 to less than 50,000; or 30,000 to less than 45,000; or 30,000 to 40,000; or 30,000 to 35,000; as measured by gel permeation chromatography (GPC) using NMP as solvent and according to ASTM D6474.

The most common commercial secondary cellulose esters are prepared by initial acid catalyzed heterogeneous acylation of cellulose to form the cellulose triester. After a homogeneous solution in the corresponding carboxylic acid of the cellulose triester is obtained, the cellulose triester is then subjected to hydrolysis until the desired degree of substitution is obtained. After isolation, a random secondary cellulose ester is obtained. That is, the relative degree of substitution (RDS) at each hydroxyl is roughly equal.

The cellulose esters useful in the present invention can be prepared using techniques known in the art, and can be chosen from various types of cellulose esters, such as for example the cellulose esters that can be obtained from Eastman Chemical Company, Kingsport, TN, U.S.A., e.g., Eastman™ Cellulose Acetate CA 398-30 and Eastman™ Cellulose Acetate CA 398-10, Eastman™ CAP 485-20 cellulose acetate propionate; Eastman™ CAB 381-2 cellulose acetate butyrate.

In one embodiment or in combination with any other embodiment, the cellulose ester can be prepared by converting cellulose to a cellulose ester with reactants that are obtained from recycled materials, e.g., a recycled plastic content syngas source. In one embodiment or in combination with any other embodiment, such reactants can be cellulose reactants that include organic acids and/or acid anhydrides used in the esterification or acylation reactions of the cellulose, e.g., as discussed herein.

In one embodiment or in combination with any of the mentioned embodiments, or in combination with any of the mentioned embodiments, of the invention, a cellulose ester composition comprising at least one recycle cellulose ester is provided, wherein the cellulose ester has at least one substituent on an anhydroglucose unit (AU) derived from recycled content material, e.g., recycled plastic content syngas.

In one embodiment or in combination with any other embodiment, the cellulose ester composition comprises cellulose ester in an amount of greater than 25%, greater than 30%, greater than 35%, greater than 40%, greater than 45%, or greater than 50% by weight, based on the total weight of the cellulose ester composition. The cellulose ester composition may comprise cellulose ester in an amount from 50 to 99 wt %, or 60 to 99 wt %, or 70 to 99 wt %, or 80 to 99 wt %, or 90 to 99 wt %, 50 to 90 wt %, or 60 to 90 wt %, or 70 to 90 wt %, or 80 to 90 wt %, or 90 to 99 wt %, or 50 to 80 wt %, or 60 to 80 wt %, or 70 to 80 wt %, or 50 to 70 wt %, or 60 to 70 wt %, or 50 to 60 wt %, all based on the total weight of the cellulose ester composition. In some embodiments, the cellulose ester used herein may comprise a combination, blend, or mixture of two or more different types of cellulose esters (i.e., cellulose mixed ester). For example, in some embodiments, the cellulose esters used herein may be comprised of a blend of two or cellulose esters having differing DSACs; however, the blend may have a total DSAC of between 2.0 and 3.0, 2.2 and 2.8, or 2.3 and 2.7

### Plasticizer

In one embodiment or in combination with any other embodiment, the cellulose ester compositions described herein can comprise at least one plasticizer. The plasticizer lowers the melt viscosity and substantially lowers the glass transition temperature (Tg) of a polymer-containing composition (e.g., the cellulose ester composition), for example, when added to an initial polymer-containing composition containing no additive, to form a modified polymer-containing composition. In one embodiment, “substantially lowers the Tg” means that the Tg of the composition decreases by at least 0.25° C., 0.5° C., 1° C., 1.5° C., 2° C., 2.5° C., 3° C., 4° C., 5° C., 6° C., 7° C., 8° C., 9° C., or 10° C. for every weight percent increase in the additive concentration, as determined between 0.1 and 20 weight percent of the additive. The plasticizer may reduce the heat deflection temperature of the composition in proportion to the amount of the additive added to the composition (i.e., in proportion to the additive concentration).

Plasticizers for cellulose esters may include glycerol triacetate (Triacetin), glycerol diacetate (Diacetin), dibutyl terephthalate, dimethyl phthalate, diethyl phthalate, poly(ethylene glycol) MW 200-600, dibutyl tartrate, di-2-methoxyethyl phthalate, ethyl o-benzoylbenzoate, triethylene glycol dipropionate, 1,2-epoxypropylphenyl ethylene glycol, 1,2-epoxypropyl (m-cresyl)ethylene glycol, 1,2-epoxypropyl(o-cresyl)ethylene glycol, β-oxyethyl cyclohexenecarboxylate, bis(cyclohexanate) diethylene glycol, triethyl citrate, polyethylene glycol, propylene glycol, polysorbate, sucrose octaacetate, acetylated triethyl citrate, acetyl tributyl citrate, Admex, tripropionin, Scandiflex, poloxamer copolymers, polyethylene glycol succinate, diisobutyl adipate, polyvinyl pyrollidone, and glycol tribenzoate, the benzoate containing plasticizers such as the Benzoflex™ plasticizer series, poly (alkyl succinates) such as poly (butyl succinate), polyethylene succinate, o-Cresyl p-toluenesulfonate, n-ethyltoluenesulfonamides, adipate based plasticizers, soybean oil epoxides such as the Paraplex™ plasticizer series, sucrose based plasticizers, dibutyl sebacate, tributyrin, sucrose acetate isobutyrate, the Resoflex™ series of plasticizers, triphenyl phosphate (TPP), triethyl phosphate (TEP), glycolates (e.g., ethyl phthalyl ethyl glycolate “EPEG” and methyl phthalyl ethyl glycolate “MPEG”), methoxy polyethylene glycol, 2,2,4-trimethylpentane-1,3-diyl bis(2-methylpropanoate), and polycaprolactones. In some embodiments, the plasticizer used herein may comprise a combination or mixture of two or more different types of plasticizers.

In one embodiment or in combination with any other embodiment, the plasticizer is a food-compliant plasticizer. By food-compliant is meant compliant with applicable food additive and/or food contact regulations where the plasticizer is cleared for use or recognized as safe by at least one (national or regional) food safety regulatory agency (or organization), for example listed in the 21 CFR Food Additive Regulations or otherwise Generally Recognized as Safe (GRAS) by the US FDA. In one embodiment or in combination with any other embodiment, the food-compliant plasticizer is triacetin or polyethylene glycol (PEG) having a molecular weight of about 200 to about 600, or about 300 to 500. In one embodiment or in combination with any other embodiment, examples of food-compliant plasticizers that could be considered can include triacetin, triethyl citrate, polyethylene glycol, benzoate esters, propylene glycol, polysorbate, sucrose octaacetate, acetylated triethyl citrate, acetyl tributyl citrate, Admex, tripropionin, Scandiflex, poloxamer copolymers, polyethylene glycol succinate, diisobutyl adipate, polyvinyl pyrollidone, and glycol tribenzoate.

In one embodiment or in combination with any other embodiment, the plasticizer is a bio-based and/or biodegradable plasticizer. Some examples of bio-based and/or biodegradable plasticizers include triacetin, triethyl citrate, acetyl triethyl citrate, polyethylene glycol, the benzoate containing plasticizers such as the Benzoflex™ plasticizer series, poly (alkyl succinates) such as poly (butyl succinate), polyethylene succinate, adipate based plasticizers, soybean oil epoxides such as the Paraplex™ plasticizer series, sucrose based plasticizers, dibutyl sebacate, tributyrin, the Resoflex™ series of plasticizers, triphenyl phosphate, glycolates, polyethylene glycol, 2,2,4-trimethylpentane-1,3-diyl bis(2-methylpropanoate), and polycaprolactones.

In one embodiment or in combination with any other embodiment, the cellulose ester composition can contain a plasticizer selected from the group consisting of PEG and MPEG (methoxy PEG). The polyethylene glycol or a methoxy polyethylene glycol composition having an average molecular weight of from 200 Daltons to 600 Daltons, wherein the composition is melt processable, biodegradable, and disintegrable.

In one embodiment or in combination with any other embodiment, the composition comprises polyethylene glycol or methoxy PEG having an average molecular weight of from 300 to 550 Daltons.

In one embodiment or in combination with any other embodiment, the composition comprises polyethylene glycol having an average molecular weight of from 300 to 500 Daltons.

In one embodiment or in combination with any other embodiment, the plasticizer does not comprise a metal fatty acid salt.

In one embodiment or in combination with any other embodiment, the plasticizer does not comprise an ionic compound.

In one embodiment or in combination with any other embodiment, the plasticizer has a melting point temperature of less than 100° C.

In one embodiment or in combination with any other embodiment, the plasticizer can be present in an amount sufficient to permit the cellulose ester composition to be melt processed (or thermally formed) into useful articles, e.g., single use plastic articles, in conventional melt processing equipment.

In one embodiment or in combination with any other embodiment, the plasticizer is present in an amount from 1% to 20% by weight, based on the weight of the cellulose ester composition take as 100% by weight. The plasticizer may be present in an amount of at least 1%, at least 2%, at least 3%, at least 4%, or at least 5%, at least 6%, at least 7%, or at least 8% by weight and/or not more than 20%, not more than 19%, not more than 18%, not more than 17%, not more than 16%, not more than 15%, not more than 14%, not more than 13%, or not more than 12% by weight.

### Flow Aid

In one embodiment or in combination with any other embodiment, the cellulose ester compositions described herein can comprise at least one flow aid. As used herein, the term “flow aid” refers to an additive other than a plasticizer that lowers the melt viscosity of a composition, for example, as measured by the Melt Flow Index (ASTM D1238/ISO 1133). Advantageously, by including a flow aid in combination with a plasticizer, the melt viscosity can be lowered to a greater extent than the same amount of a plasticizer alone. For example, in some embodiments, a cellulose ester composition comprising 10% by weight plasticizer and 2% by weight of a flow aid may have a lower melt viscosity than a cellulose ester composition comprising 12% by weight plasticizer and no flow aid. Additionally, or alternatively, a cellulose ester composition comprising 10% by weight plasticizer and 2% by weight of a flow aid may have the same melt viscosity as a cellulose ester composition comprising 20% by weight plasticizer and no flow aid.

In one embodiment or in combination with any other embodiment, the flow aid does not substantially lower the glass transition temperature (Tg) of a polymer-containing composition (e.g., a cellulose ester composition), for example, when added to an initial polymer-containing composition containing no additive to form a modified polymer-containing composition. In one embodiment, “does not substantially lower the Tg” means that the Tg decreases by not more than C, 0.5° C., 1° C., 1.5° C., 2° C., 2.5° C., 3° C., 4° C., 5° C., 6° C., 7° C., 8° C., 9° C., or 10° C. for every weight percent increase in the additive concentration, as determined between 0.1 and 10 weight percent of the additive. In one embodiment, the flow aid does not reduce the heat deflection temperature of the composition in proportion to the amount of the additive added to the composition (i.e., in proportion to the additive concentration). In one embodiment, “does not reduce the HDT” means that the HDT decreases by not more than C, 0.5° C., 1° C., 1.5° C., 2° C., 2.5° C., 3° C., 4° C., 5° C., 6° C., 7° C., 8° C., 9° C., or 10° C. for every weight percent increase in the additive concentration, as determined between 0.1 and 10 weight percent of the additive. The flow aid may allow for compounding of cellulose ester materials, such as cellulose acetate, with lower levels of plasticizer as compared to formulations without the flow aid.

In one embodiment or in combination with any other embodiment, the flow aid is a salt. The flow aid salt may be solid at ambient temperatures for ease of handling but will melt during processing (for example, compounding, extrusion, thermoforming, injection molding). The flow aid may be a salt with a melting point of 100° C. to 250° C. Thus, the flow aid salt may also be referred to as an ionic melt, with a melting temperature of 100° C. to 250° C. When heated, the ionic solid salt melts to form a liquid (or molten) ionic compound.

The flow aid preferably has relatively low volatility and/or low water solubility. Low volatility inhibits the flow aid from volatilizing during melt processing, while low water solubility helps to reduce leaching and minimizes the impact of water on the glass transition temperature (Tg) and heat deflection temperature (HDT) of cellulose acetate. Relative volatility may be characterized according to thermogravimetric analysis (TGA). For example, in some embodiments, when the flow aid is heated in air from 20° C. to 300° C. at a rate of 20° C. per minute, the flow aid exhibits a weight loss of less than 20%, less than 15%, less than 10%, less than 5%, less than 2%, less than 1%, or substantially no weight loss (i.e., any measured weight loss is attributable only to the loss of moisture content).

In one embodiment or in combination with any other embodiment, the flow aid may be an ionic melt composed of both cation and anion species. The cation may be any cation, including organic or inorganic cations. Exemplary organic cations include ammonium, imidazolium, pyridinium, pyrrolidinium, triazolium, phosphonium, piperidinium, morpholinium, tetrazolium, pyrazolium, sulfonium or thiazolium ions. An amino acid may function as the cation, specifically arginine, lysine, or histidine. The cation may preferably be inorganic. Exemplary inorganic cations include ions derived from Group 1 to Group 12 in the periodic table, or from Group 1 to Group 2 in the periodic table. The anion may be any anion, including organic or inorganic anions. The anion may preferably be organic. Amino acids may function as organic anions, especially aspartic acid and glutamic acid. The organic anion may preferably be a carboxylic acid, such as a fatty acid of alkyl chain length C8 to C26, or C12 to C18 fatty acid, or mixture of C12 to C18 fatty acids. The fatty acid may be synthetic or natural, linear or branched, saturated or unsaturated. Exemplary linear, saturated, natural fatty acids include stearic acid, lauric acid, palmitic acid, and myristic acid. Flow aids comprising fatty acids may also function as release aids and/or hydrophobic additives to melt-processed cellulose acetate compositions.

In one embodiment or in combination with any other embodiment, the flow aid may be aluminum, calcium, magnesium, potassium, sodium and/or zinc salts of fatty acids. These may also function as release aids and/or hydrophobic additives to melt-processed cellulose acetate compositions. Aluminum, calcium, magnesium, potassium, and sodium salts may preferably be allowed as food additives according to 21 CFR Food Additive Regulations or otherwise Generally Recognized as Safe (GRAS) by the US FDA, and would be suitable as an additive or flow aid in a melt-processed article used to contain food. Aluminum, calcium, and magnesium salts are preferably not water soluble and will resist leaching from the articles. Magnesium fatty acid salts, in particular, tend to have compatibility with the plasticized cellulose acetate and form rigid articles that are transparent or nearly transparent without a waxy surface bloom. Magnesium fatty acid salts may contain one to two mole equivalents of the fatty acid. The fatty acid may have an alkyl chain length of C12 to C18 or comprise a mixture of fatty acids in this range. In one embodiment or in combination with any other embodiment, the flow aid comprises a blend of two or more fatty acid salts. In one embodiment or in combination with any other embodiment, the flow aid comprises magnesium stearate, either alone or in a blend with other metal fatty acid salts.

In one embodiment or in combination with any other embodiment, the flow aid does not comprise an ester.

In one embodiment or in combination with any other embodiment, the flow aid comprises an ionic compound.

In one embodiment or in combination with any other embodiment, the flow aid has a melting point temperature of greater than 100° C.

In one embodiment or in combination with any other embodiment, the flow aid may be included in the compounded CE composition or melt-processed composition at greater than 0.3%, greater than 0.4%, greater than 0.5%, greater than 0.6%, greater than 0.7%, greater than 0.8%, greater than 0.9%, greater than 1.0%, greater than 1.1%, greater than 1.2%, greater than 1.3%, greater than 1.4%, or greater than 1.5% by weight and/or not more than 10%, not more than 9%, not more than 8%, not more than 7%, not more than 6%, or not more than 5% by weight, with the total weight of the composition taken as 100% by weight. The flow aid may be included in the composition at 1% to 10% by weight. Such compositions may further comprise a plasticizer and a stabilizer, as described herein.

### Stabilizer

One or more stabilizers may be included that are capable of inhibiting or reducing thermal degradation or resulting undesirable properties of the polymer compositions and articles during compounding or other processing of the CE composition. In one embodiment or in combination with any other embodiment, the one or more stabilizers comprise an organic acid (or organic acid blend). The organic acid (or blend) may have a pKa greater than 3.

In one embodiment or in combination with any other embodiment, the CE composition comprises one or more carboxylic acid stabilizers. Suitable stabilizers may include organic carboxylic acids capable of neutralizing alkalinity in the composition that may form color during melt processing. For example, the organic carboxylic acids may include citric acid, succinic acid, adipic acid, fumaric acid, maleic acid, malic acid, lauric acid, oxalic acid, myristic acid, oleic acid, palmitic acid, and stearic acid, and combinations thereof.

In one embodiment or in combination with any other embodiment, the one or more stabilizers may be included in the compounded CE composition or melt-processed composition at 0.1% to 10%, 0.5% to 5%, or 1% to 10% by weight, with the total weight of the composition taken as 100% by weight.

### Biodegradable Polymers

In one embodiment or in combination with any other embodiment, the cellulose ester compositions described herein comprise a biodegradable cellulose ester (BCE) component that comprises at least one BCE, which may include one or more of the cellulose esters described herein, and a biodegradable polymer component that comprises at least one other biodegradable polymer (other than the BCE). In one embodiment or in combination with any other embodiment, the other biodegradable polymer can be chosen from polyhydroxyalkanoates (PHAs and PHBs), polylactic acid (PLA), polycaprolactone polymers (PCL), polybutylene adipate terephthalate (PBAT), polyethylene succinate (PES), polyvinyl acetates (PVAs), polybutylene succinate (PBS) and copolymers (such as polybutylene succinate-co-adipate (PBSA)), cellulose esters, cellulose ethers, starch, proteins, derivatives thereof, and combinations thereof. In one embodiment or in combination with any other embodiment, the cellulose ester composition comprises two or more biodegradable polymers. In one embodiment or in combination with any other embodiment, the cellulose ester composition contains a biodegradable polymer (other than the BCE) in an amount from 0.1 to less than 50 wt %, or 1 to 40 wt %, or 1 to 30 wt %, or 1 to 25 wt %, or 1 to 20 wt %, based on the cellulose ester composition. In one embodiment or in combination with any other embodiment, the cellulose ester composition contains a biodegradable polymer (other than the BCE) in an amount from 0.1 to less than 50 wt %, or 1 to 40 wt %, or 1 to 30 wt %, or 1 to 25 wt %, or 1 to 20 wt %, based on the total amount of BCE and biodegradable polymer. In one embodiment or in combination with any other embodiment, the at least one biodegradable polymer comprises a PHA having a weight average molecular weight (Mw) in a range from 10,000 to 1,000,000, or 50,000 to 1,000,000, or 100,000 to 1,000,000, or 250,000 to 1,000,000, or 500,000 to 1,000,000, or 600,000 to 1,000,000, or 600,000 to 900,000, or 700,000 to 800,000, or 10,000 to 500,000, or 10,000 to 250,000, or 10,000 to 100,000, or 10,000 to 50,000, measured using gel permeation chromatography (GPC) with a refractive index detector and polystyrene standards employing a solvent of methylene chloride. In one embodiment or in combination with any other embodiment, the PHA can include a polyhydroxybutyrate-co-hydroxyhexanoate.

### Nucleating Agent

Nucleating agent means a chemical or physical material that provides sites for cells to form in a molten formulation mixture, such as within a CE melt resin. As will be described in more detail below, nucleating agents may be added to compounded CE material during the compounding process. Alternatively, or in addition, nucleating agents may be added during the foam sheet production process. For example, the nucleating agents may be blended with the formulation that is introduced into the hopper of the extruder of the extruding section. Alternatively, the nucleating agents may be added to the CE melt resin in the extruder itself. Nucleating agents may include physical nucleating agents and chemical nucleating agents. Physical nucleating agents are materials that are immiscible with the polymer matrix of the CE melt resin at the extrusion temperature of the extrusion section. Chemical nucleating agents are materials that react (e.g., decompose) during extrusion (e.g., at the extrusion temperature within the extruder) to form physical nucleating agents. Thus, chemical nucleating agents may be considered (and referred to herein as) precursors of in situ formed physical nucleating agents.

Suitable physical nucleating agents will comprise fine particles having desirable particle sizes and/or shapes to create cell nucleation sites within the CE melt resin. For example, in some embodiments, physical nucleating agents will have a mean particle size of less than 1000 microns, less than 500 microns, less than 100 microns, less than 50 microns, less than 25 microns, less than 20 microns, less than 10 microns, less than 5 microns, less than 2 microns, less than 1.5 microns, and/or less than 1.0 microns. However, in some other embodiments, it may be preferred to have nanoscale-sized particles. Furthermore, in some embodiments, physical nucleating agents will preferably have a high aspect ratio (i.e., width:height). For example, in some embodiments, physical nucleating agents will have a mean aspect ratio of greater than 1:1, greater than 2:1, greater than 5:1, greater than 10:1, greater than 20:1, greater than 30:1, greater than 40:1, greater than 50:1, greater than 75:1, and/or greater than 100:1. Furthermore still, as noted above, physical nucleating agents should be immiscible with the polymer matrix of the CE melt resin at the extrusion temperature of the extrusion section. As such, in some embodiments, the physical nucleating agents should have a melting temperature at least 220° C., at least 230° C. of at least 240° C., at least 250° C., at least 275° C., at least 300° C., at least 325° C., or at least 350° C. Nevertheless, the physical nucleating agents may be selected such that they have the ability to, after melting, recrystallize upon cooling.

Examples of suitable inorganic physical nucleating agents include, but are not limited to, minerals such as talc, CaCO3, mica, and mixtures of at least two of the foregoing. One representative example is Heritage Plastics HT6000 Linear Low Density Polyethylene (LLDPE) Based Talc Concentrate. Other inorganic physical nucleating agents include wollastonite, silica, silicon oxide, titanium oxide, magnesium oxide, aluminum oxide and calcium silicate, barium sulfate, Kaolin, aluminum tryhydrateATH (AI (OH) 3), MDH (Mg(OH)₂), Diatomaceous earth, magnetite/hematite, halloysite, zinc oxide, and titanium dioxide. In some embodiments, the inorganic nucleating agents will comprise oxides, such as metal oxides or mixed metal oxides, such as those selected from one or more of the following: aluminum oxide, antimony oxide, arsenic oxide, bismuth oxide, boron oxide, calcium oxide, gallium oxide, iron oxide, lithium oxide, magnesium oxide, silicon oxide, and titanium oxide. In other embodiments, the inorganic nucleating agents will comprise silicates, such as silicates selected from one or of the following: magnesium silicate and calcium silicate.

It has been discovered that bio-based natural, particulate materials derived from renewable organic sources (e.g., organic nucleating agents) can also serve as effective physical nucleating agents. Natural materials that can be physical nucleating agents include material comprised of cellulose fibers and/or cellulose starch. Examples include, but are not limited to almond shell flour, animal fiber, apricot shell flour, bamboo flour, tree bark flour, clam shell flour, coconut shell flour, coconut coir, cork flour, corn cob flour, corn cob grit, cottonseed hulls, flock & fiber, hazelnut shell flour, kenaf flour, natural fibers, nutshell hull & flour, oat fiber powder, olive stone flour, peanut hulls flour, pecan shell flour, pine-nut shell powder, pistachio-nut shell flour, plant fiber, rice hull flour, rice hull grit, rice husk, soy bean flour, starch flour (hydrophobic), walnut shell flour, wheat chaff, wheat husk, and wood flour. Other organic physical nucleating agents include cellulose powder, chitin, chitosan, stearic acid metal salts, carbon black, and dolomite.

As noted above, suitable chemical nucleating agents (or precursors of in situ formed physical nucleating agents) are configured to decompose to create cell nucleation sites in the CE melt resin when a threshold chemical reaction temperature is reached. These small cells act as nucleation sites for larger cell growth from a physical or other type of blowing agent. In some embodiments, the precursors are configured to form a gas during extrusion of the particulate material, such as CO² or N².

Examples of chemical nucleating agents include but are not limited to acids, such as citric acid or a citric acid-based material. Other acids may include lauric acid, stearic acid, tartaric acid, ascorbic acid, propionic acid, and hexanoic acid. One representative example is HYDROCEROL™ CF-40E (available from Clariant Corporation), which contains citric acid and a crystal nucleating agent. In some embodiments, the chemical nucleating agents will include a combination of an acid and a base, such as a carbonate, which may include sodium bicarbonate, zinc bicarbonate, potassium bicarbonate, sodium carbonate, potassium carbonate, etc. For instance, a representative example of a chemical nucleating agent is a combination of citric acid and sodium bicarbonate. In some embodiments, chemical nucleating agents may include a carrier within which the active components of the nucleating agents are dispersed. For example, yet another representative example of chemical nucleating agents is a combination of citric acid, sodium bicarbonate, and a carrier. In some embodiments, the carrier may comprise polystyrene. However, the carrier may comprise other compositions, such as various biopolymers (e.g., polybutylene succinate, Capa polyesters, etc.), polyolefins, acrylic copolymers (e.g., ethylene methyl acrylate), or the like. In some such embodiments, the citric acid and sodium bicarbonate may comprise about half (in wt %) of the chemical nucleating agents, while the carrier makes up the remaining half (in wt %). Furthermore, in some of such embodiments, there may be more sodium bicarbonate than citric acid in the chemical nucleating agent. For instance, there may be about three times as much (in wt %) sodium bicarbonate than citric acid in the chemical nucleating agent. It should also be understood that in some embodiments, no carrier may be required or used, such as the case with the nucleating agent being Hecofoam or Hydrocerol.

In one embodiment or in combination with any of the embodiments mentioned herein, the nucleating agents are present at from 0.1 to 10 wt %, from 0.1 to 5.0 wt %, at least 0.1 wt %, at least 0.25 wt %, at least 0.5 wt % at least 1.0 wt %, at least 1.25 wt %, at least 1.5 wt %, at least 1.75 wt %, at least 2.0 wt %, at least 2.25 wt %, at least 2.5 wt %, at least 2.75 wt %, or at least 3.0 wt %, or at least 3.5 wt %, or at least 4.0 wt %, or at least 4.5 wt % and/or less than 7.5 wt %, less than 5 wt %, less than 4 wt %, less than 3 wt %, less than 2 wt %, or less than 1.0 wt %, all based on the total weight of the cellulose ester composition. In some embodiments, the nucleating agents used herein may comprise a combination or mixture of two or more different types of nucleating agents.

It is noted that the cellulose ester material, whether in the form of compounded CE material or CE melt resin, will generally be able to accept a maximum amount of nucleating agent that can function to form nucleation sites. Any remaining nucleating agent that is added to the cellulose ester material will remain as filler. Fillers can provide various properties to the resulting cellulose ester foams and/or articles based on the type of filler used. For example, some fillers can provide increased/decreased density, ductility, Young's modulus, yield strength, heat deflection temperature, permeability, impact resistance, elongation to break, adhesion properties, biodegradation, etc. of the cellulose ester material. Fillers can also be used to alter the visual characteristics (e.g., color, opacity, etc.) and tactile characteristics (e.g., material continuous, surface roughness, etc.) of the cellulose ester material.

### Blowing Agents

A blowing agent refers to a physical or a chemical material (or combination of materials) that acts to expand nucleation sites. Blowing agents may include chemical blowing agents, physical blowing agents, combinations thereof, or several types of chemical and physical blowing agents. The blowing agents function to reduce density of a material by expanding cells formed in the molten formulation at the nucleation sites. The blowing agent may be added to the CE melt resin, for example, in an extruder. The hygroscopic nature of biobased or biodegradable particulate natural fillers allows them to absorb moisture and carry the absorbed water into the molten resin mixture where the water can act as a physical blowing agent.

Examples of physical blowing agents include H₂O, N₂, CO₂, alkanes, alkenes, esters, ethers, ketones, argon, helium, air or mixtures. In addition, it has been surprisingly discovered that the hygroscopic nature of bio-based or particulate natural fillers allows them to absorb moisture and carry the absorbed water into the molten resin mixture where the water can act as a physical blowing agent. Hygroscopic biodegradable natural fillers can be formulated into a composition and allowed to absorb moisture prior to the foaming process, where the water then is released to act as a physical blowing agent. Beneficially, the water may also be used as a plasticizer for the cellulose ester resin. Furthermore, in some embodiments, physical blowing agents may include hydrocarbons, such as pentane/isopentane or butane/isobutane. Other hydrocarbons may include propane, ethane, methane, hexane, cyclohexane, cyclopentane, cyclobutene, or the like.

Chemical blowing agents are materials that degrade or react to produce a gas (e.g., CO₂ or N₂). Such gasses expand the cells within the molten resin mixture and/or resulting foam mixture to produce a structural material with a plurality of gaseous voids dispersed throughout. Chemical blowing agents may be endothermic or exothermic. Chemical blowing agents typically degrade at a certain temperature to decompose and release gas. Examples of chemical blowing agents include azodicarbonamide, acids (e.g., citric acid), and carbonates, such as sodium bicarbonate, sodium carbonate, ammonium bicarbonate, ammonium carbonate, zinc carbonate, and the like and combinations thereof.

In one embodiment or in combination with any of the embodiments mentioned herein, the blowing agent is present at from 0.3 to 1.5 wt %, or 0.3 to 2.0 wt %, or 0.3 to 2.5 wt %, or 0.3 to 3.0 wt %, or 0.3 to 3.5 wt %, or 0.3 to 4.0 wt %, or 0.3 to 8%, or 1.3 to 1.5 wt %, or 1.3 to 2.0 wt %, or 1.3 to 2.5 wt %, or 1.3 to 3.0 wt %, or 1.3 to 3.5 wt %, or 1.3 to 4.0 wt %, or 1.3 to 4.5 wt %, or 1.3 to 5.0 wt %, or 1.3 to 5.5 wt %, or 1.5 to 3.0 wt %, or 1.5 to 4.0 wt %, or 1.5 to 5.0 wt %, or 1.5 to 6.0 wt %, or 2.0 to 3.0 wt %, or 2.0 to 4.0 wt %, or 2.0 to 5.0 wt %, or 2.0 to 6.0 wt %, or 2.5 to 3.0 wt %, or 2.5 to 4.0 wt %, or 2.5 to 5.0 wt %, or 2.5 to 6.0 wt %, or 3.0 to 4.0 wt %, or 3.0 to 5.0 wt %, or 3.0 to 6.0 wt %, or 0.0 to 9.0 wt %, or 0.5 to 9.0 wt %, or 1.0 to 9.0 wt %, or 1.5 to 9.0 wt %, or 2.0 to 9.0 wt %, or 2.5 to 9.0 wt %, or 3.0 to 9.0 wt %, or 3.5 to 9.0 wt %, or 4.0 to 9.0 wt %, or 4.5 to 9.0 wt %, or 5.0 to 9.0 wt %, or 5.5 to 9.0 wt %, or 6.0 to 9.0 wt %, or 6.5 to 9.0 wt %, or 7.0 to 9.0 wt %, or 7.5 to 9.0 wt %, or 8.0 to 9.0 wt %, or 8.5 to 9.0 wt %, all based on the total weight of the cellulose ester composition. In some embodiments, the blowing agents used herein may comprise a combination or mixture of two or more different types of blowing agents.

### Surface Modifying Additives

Surface modifying additives refer to materials that can be added to cellulose ester compositions to modify the structure of the compositions (or the resulting foam articles) to improve processing of the cellulose ester compositions. For example, adding surface modifying additives to the compounded CE material (e.g., to the pellets during the compounding process) or to the CE melt resin (e.g., during an extrusion process) can improve processing by reducing unwanted sticking of the CE melt resin to the die or mandrel (or to other components of the foam sheet production process). Such reduction in sticking may be achieved by the surface modifying additives inhibiting the fusing of cellulose esters caused by plasticizers. The addition of surface modifying additives may also reduce blocking of the cellulose ester foam sheets produced at the sheet forming section. Furthermore, surface modifying additives may also improve the foam sheet production process by allowing the process to be performed at lower temperatures.

Furthermore still, in some embodiments, the surface modifying additives may function as anti-static additives, which inhibit electrical sparks or arcing in the CE melt resin. The inhibition of electrical sparks or arcing can be particularly important when hydrocarbons are used as blowing agents, so as to reduce the chance of igniting the hydrocarbons and causing fires. Beneficially, surface modifying additives may also reduce the diffusion of blowing agents, such as hydrocarbons, out of the foam sheets or resulting articles. In some embodiments, hydrocarbons themselves may be used as surface modifying additives.

Nevertheless, more general examples of surface modifying additives that may be used with compounded CE material (e.g., during the compounding process) or to the CE melt resin (e.g., during the foam sheet production process) according to embodiments of the present invention include fatty acids, such as palmitic acid, tallow acid, stearic acid, oleic acid, linoleic and linolenic acids, arachidic/behenic acids, behenic acid, and erucic acid. Surface modifying additives may also include fatty acid amides, such as erucamides, oleoamides, stearmides, behenamides, ethanolamides, secondary amides, and bisamides.

Additional examples of surface modifying additives may include glycerol esters and/or stearate esters, such as monoglycerides, diglycerides, and triglycerides. The monoglycerides may include glycerol monostearate or monoglyceride derivatives, such as diacetyl tartaric acid esters of mono- and diglycerides (DATEM), ethoxylated monoglyceride, succinyl monoglyceride, and propylene glycol monoesters (PGME). Examples of surface modifying additives may also include metallic stearates such as aluminum stearate, calcium stearate, lithium stearate, magnesium stearate, sodium stearate, zinc stearate, and/or combinations thereof (e.g., Calcium/Zinc stearates). Examples of surface modifying additives may also include waxes, such as polyolefin waxes (polypropylene wax and polyethylene wax), oxidized olefin waxes, ethylene acrylic acid (EAA) copolymer waxes, ethylene methyl acrylate (EMA) copolymer waxes, EAA ionomer axes, acrylic waxes, and/or natural waxes, such as rice bran wax, sunflower wax, sugar cane wax, candelilla wax, soy wax, bees wax, candelilla wax, and carnauba waxes.

Other, non-exclusive examples of surface modifying additives include aliphatic diesters (e.g., dioctyl adipate), polyglycol diesters, alkyl alkyether diesters, aromatic triesters, polyester resins, chlorinated hydrocarbons, halogenated hydrocarbons, alkylether monoesters, and alkyl monoesters. In addition, various oils may be used as surface modifying additives, such as aromatic oils, napthenic oils, glyceride oils, silicon oils, and epoxidized oils (e.g., soybean oil and linseed oil). Thus, in some embodiments, the surface modifying additives comprise plasticizers, such as aliphatic diester plasticizers, polyester plasticizers, and the like. Furthermore, in some embodiments, surface modifying additives may comprise a polyhedral oligomeric silsesquioxane (POSS).

More generally, surface modifying additives used in embodiments of the present invention may have a lower polarity than the cellulose ester in compounded CE material (e.g., during the compounding process) or to the CE melt resin (e.g., during the foam sheet production process). For example, the surface modifying additives may have (based on Hansen solubility parameters): a total solubility parameter o of less than 25 MPa^{1/2}, less than 20 MPa^{1/2}, or less than 19.5 MPa^{1/2}; a dispersion force solubility parameter Od of less than 18 MPa^{1/2}, less than 16 MPa^{1/2}, or less than 14 MPa^{1/2}; a dipolar intermolecular force solubility parameter od of less than 12 MPa^{1/2}, less than 8 MPa^{1/2}, or less than 4 MPa^{1/2}; and/or a hydrogen bond solubility parameter Oh of less than 11 MPa^{1/2}, less than 10 MPa^{1/2}, or less than 9 MPa^{1/2}. However, in some other embodiments, the surface modifying additives used in embodiments of the present invention may have a higher polarity than the cellulose ester in compounded CE material (e.g., during the compounding process) or to the CE melt resin (e.g., during the foam sheet production process). For example, the surface modifying additives may have (based on Hansen solubility parameters): a total solubility parameter o of more than 21.5 MPa^{1/2}, more than 23 MPa^{1/2}, or more than 25 MPa^{1/2}. In addition, in some embodiments, surface modifying additives may have a boiling point greater than 200° C., greater than 220° C., greater than 240° C., greater than 260° C., greater than 280° C., or greater than 300° C. Furthermore, the surface modifying additives may have a molecular weight greater than 100 g/mol, greater than 150 g/mol, greater than 220 g/mol, greater than 260 g/mol, greater than 300 g/mol, or greater than 340 g/mol and/or no more than 1000 g/mol, no more than 2500 g/mol, or no more than 5000 g/mol. Furthermore still, it may be preferable for the surface modifying additives to not be soluble in the plasticizer(s) used in the cellulose ester compositions. For instance, it may be preferable for the surface modifying additives to not be soluble in triacetin. Finally, in some embodiments, the surface modifying additives may be biodegradable and/or food-compliant or FDA approved.

In one embodiment or in combination with any of the embodiments mentioned herein, the surface modifying additives are present at from 0.05 to 0.75 wt %, or 0.05 to 1.0 wt %, or 0.05 to 2.5 wt %, or 0.05 to 5.0 wt %, or 0.75 to 1.0 wt %, or 0.75 to 2.5 wt %, or 0.75 to 5.0 wt %, or 0.1 to 1.0 wt %, or 0.1 to 2.5 wt %, 0.1 to 5.0 wt %, or 1.0 to 2.5 wt %, or 1.0 to 5.0 wt %, or 2.5 to 5.0 wt %, all based on the total weight of the cellulose ester composition. In some embodiments, the surface modifying additives used herein may comprise a combination or mixture of two or more different types of surface modifying additives.

### Articles

In one embodiment or in combination with any of the embodiments mentioned herein, the cellulose ester compositions may be formed into sheets and/or articles in the article forming process described above. The sheets and/or articles may be foamed or rigid. In some embodiments, formed sheets may be further processed (e.g., thermoformed) into useful articles. In some embodiments, the articles may be biodegradable and/or compostable, and/or the articles may have superior mechanical properties (e.g., strength, density, cell size, absorption, etc.).

Exemplary articles comprising the cellulose ester composition are provided wherein the article is used in food service and grocery items, horticulture, agriculture, recreation, coatings, fibers, nonwovens, and home/office applications. Example of food service, and grocery items include, but are not limited to, straws, cup lids, composite lids, portion cups, beverage cups, trays, bowl, plates, food containers, container lids, clamshell containers, cutlery, utensils, stirrers, jars, jar lids, bottles, bottle caps, bags, flexible packaging, wrap, produce baskets, produce stickers, and twine. Examples of horticulture and/or agriculture uses include, but are not limited to, plant pots, germination trays, transplant pots, plant tags, buckets, bags for soil & mulch, trimmer string, agricultural film, mulch film, greenhouse film, silage film, compostable bags, film stakes, hay baling twine. Examples of recreation articles include, but are not limited to, toys, sporting goods, fishing tackle, golf gear, and camping goods. Toys can include, but are not limited to, beach toys, blocks, wheels, propellers, sippy cups, doll accessories, and pet toys. Sporting goods can include, but are not limited to, whistles, whiffle balls, paddles, nets, foam balls & darts, and artificial turf). Fishing tackle can include, but are not limited to, floats, lures, nets, and traps. Golf gear includes, but is not limited to, tees, practice balls, ball markers, divot tools. Camping gear includes, but is not limited it, tent stakes, eating utensils, and cord/rope). Examples of home and office articles include, but are not limited to, gift cards, credit cards, signs, labels, report covers, mailers, tape, tool handles, toothbrush handles, writing utensils, combs, film canisters, wire insulation, screw caps, and bottles.

In one embodiment or in combination with any of the embodiments mentioned herein, the articles are made from moldable thermoplastic material comprising the cellulose ester compositions, as described herein.

In one embodiment or in combination with any of the embodiments mentioned herein, the articles are single use food contact articles. Examples of such articles that can be made with the cellulose ester compositions include cups, trays, multi-compartment trays, clamshell packaging, candy sticks, films, sheets, trays and lids (e.g., thermoformed), straws, plates, bowls, portion cups, food packaging, liquid carrying containers, egg cartons, solid or gel carrying containers, and cutlery. In embodiments, the cellulose ester may be a coating or layer of an article. The articles may comprise fibers. In embodiments, the articles can be horticultural articles. Examples of such articles that can be made with the cellulose ester compositions include plant pots, plant tags, mulch films, and agricultural ground cover.

Articles formed using compositions in accordance with embodiments of the present invention can advantageously exhibit desirable heat stability properties. The heat stability of the articles can be characterized, for example, by the heat deflection temperature of the compositions as tested according to ASTM D648, ISO 75. In one embodiment or in combination with any of the embodiments mentioned herein, the CE composition has a heat deflection temperature of greater than 50° C., greater than 55° C., or greater than 60° C., when tested under low pressure at 100% relative humidity (RH) according to ASTM D648, ISO 75.

Further Inventive Concepts Related to Compositions, Processes, and Systems for Producing Pellets, Sheets, and/or Articles

In one embodiment or in combination with any of the embodiments mentioned herein, the sheet or article is industrial compostable or home compostable. In one subclass of this class, the sheet or article is industrial compostable. In one sub-subclass of this subclass, the sheet or article has a thickness that is less than 6 mm. In one sub-subclass of this subclass, the sheet or article has a thickness that is less than 3 mm. In one sub-subclass of this subclass, the article has a thickness that is less than 1.1 mm. In one subclass of this class, the sheet or article is home compostable. In one sub-subclass of this subclass, the sheet or article has a thickness that is less than 6 mm. In one sub-subclass of this subclass, the sheet or article has a thickness that is less than 3 mm. In one sub-subclass of this subclass, the sheet or article has a thickness that is less than 1.1 mm. In one sub-subclass of this subclass, the sheet or article has a thickness that is less than 0.8 mm. In one sub-subclass of this subclass, the sheet or article has a thickness that is less than 0.6 mm. In one sub-subclass of this subclass, the sheet or article has a thickness that is less than 0.4 mm.

In one embodiment or in combination with any of the embodiments mentioned herein, the thickness of the sheet or article is from 1 to 10 mm, from 1 to 8 mm, from 2 to 8 mm, from 3 to 7 mm, from 4 to 6 mm, about 4 mm, about 5 mm, about 6 mm, about 7 mm, or about 8 mm. However, it should be noted that the sheet or article may have other, larger sizes. For example, in some embodiments, the sheet or article may have a thickness from 0.5 to 24 inches, from 1 to 15 inches, or 3 to 12 inches.

The compositions used to prepare the biodegradable cellulose acetate sheets and articles can comprise other additives such as fillers, odor modifiers, waxes, compatibilizers, biodegradation promoters, dyes, pigments, colorants, lubricants, anti-oxidants, viscosity modifiers, antifungal agents, antibacterial agents, softening agents, mold release agents, UV absorbers, and combinations thereof. Each additional additive may be present in the cellulose ester-based material in an amount less than 10 wt. %, less than 5 wt. % less than 4 wt. %, less than 3 wt. %, less than 2 wt. %, or less than 1.0 wt. %.

As noted above, it should be understood that the same type of compounds or materials can be identified for or included in multiple categories of components in the cellulose ester compositions. For example, polyethylene glycol (PEG) could function as a plasticizer or as an additive that does not function as a plasticizer, such as a hydrophilic polymer or biodegradation promotor, e.g., where a lower molecular weight PEG has a plasticizing effect and a higher molecular weight PEG functions as a hydrophilic polymer but without plasticizing effect.

In one embodiment or in combination with any other embodiment mentioned herein, the composition further comprises a photodegradation catalyst. In one class of this embodiment, the photodegradation catalyst is a titanium dioxide, or an iron oxide. In one subclass of this class, the photodegradation catalyst is a titanium dioxide. In one subclass of this class, the photodegradation catalyst is an iron oxide.

In one embodiment or in combination with any other embodiment mentioned herein, the composition further comprises a pigment. In one class of this embodiment, the pigment is a titanium dioxide, a carbon black, or an iron oxide. In one subclass of this class, the pigment is a titanium dioxide. In one subclass of this class, the pigment is a carbon black. In one subclass of this class, the pigment is an iron oxide. In one subclass of this class, the pigment is a biodegradable particulate natural filler.

### Definitions

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the term “flow aid” refers to an additive other than a plasticizer that lowers the melt viscosity of a composition, for example, as measured by the Melt Flow Index (ASTM D1238/ISO 1133).

As used herein, the term “bio-based” refers to a material (e.g., polymer(s)) composed in whole, or in significant part of, biological products or renewable agriculture materials.

To be considered “compostable,” a material must meet the following four criteria: (1) the material should pass biodegradation requirement in a test under controlled composting conditions at elevated temperature (58° C.) according to ISO 14855-1 (2012) which correspond to an absolute 90% biodegradation or a relative 90% to a control polymer, (2) the material tested under aerobic composting condition according to ISO16929 (2013) must reach a 90% disintegration; (3) the test material must fulfill all the requirements on volatile solids, heavy metals and fluorine as stipulated by ASTM D6400 (2012), EN 13432 (2000) and ISO 17088 (2012); and (4) the material should not cause negative on plant growth.

As used herein, the term “biodegradable” generally refers to the biological conversion and consumption of organic molecules. Biodegradability is an intrinsic property of the material itself, and the material can exhibit different degrees of biodegradability, depending on the specific conditions to which it is exposed. The term “disintegrable” refers to the tendency of a material to physically decompose into smaller fragments when exposed to certain conditions. Disintegration depends both on the material itself, as well as the physical size and configuration of the article being tested. Ecotoxicity measures the impact of the material on plant life, and the heavy metal content of the material is determined according to the procedures laid out in the standard test method.

To be considered “biodegradable,” under home composting conditions according to the French norm NF T 51-800 and the Australian standard AS 5810, a material must exhibit a biodegradation of at least 90 percent in total (e.g., as compared to the initial sample), or a biodegradation of at least 90 percent of the maximum degradation of a suitable reference material after a plateau has been reached for both the reference and test item. The maximum test duration for biodegradation under home compositing conditions is 1 year.

To be considered “biodegradable,” under industrial composting conditions according to ASTM D6400 and ISO 17088, at least 90 percent of the organic carbon in the whole item (or for each constituent present in an amount of more than 1% by dry mass) must be converted to carbon dioxide by the end of the test period when compared to the control or in absolute. According to European standard ED 13432 (2000), a material must exhibit a biodegradation of at least 90 percent in total, or a biodegradation of at least 90 percent of the maximum degradation of a suitable reference material after a plateau has been reached for both the reference and test item. The maximum test duration for biodegradability under industrial compositing conditions is 180 days.

In order to be considered “biodegradable,” under soil composting conditions according the OK biodegradable SOIL conformity mark of Vinçotte and the DIN Geprüft Biodegradable in soil certification scheme of DIN CERTCO, a material must exhibit a biodegradation of at least 90 percent in total (e.g., as compared to the initial sample), or a biodegradation of at least 90 percent of the maximum degradation of a suitable reference material after a plateau has been reached for both the reference and test item. The maximum test duration for biodegradability under soil compositing conditions is 2 years.

In one embodiment or in combination with any other embodiment, when the article is a 25.4 mm×25.4 mm×1 mm foam with a density of 0.643 g/cm³, the article exhibits at least 50%, or at least 55%, or at least 60%, or at least 65%, or at least 70%, or at least 75%, or at least 80%, or at least 85% disintegration under the ISO20200 standard in industrial or home composting test conditions. In one class of this embodiment, the article exhibits from 50% to 90%, or from 55% to 90%, or from 60% to 90%, or from 65% to 90% disintegration under the ISO20200 standard in industrial or home composting test conditions.

### Examples

### Example 1. Non-Volatile Fatty Acid Metal Salts were Synthesized from Fatty Acids and the Metal Oxide or Hydroxide

Magnesium salts of fatty acids were synthesized as non-volatile hydrophobic additives. A series of Magnesium mono- and di-fatty acid salts were made separately from lauric acid (C12), palmitic acid (C16) or stearic acid (C18). A catalytic amount of acid was then added to initiate the neutralization reaction. Magnesium hydroxide was dispersed in water (1 mole Mg(OH)₂/L water) and heated to above the melting point of the fatty acid (typically 85° C.). Citric acid was added as an initiator (0.05 eq) to the magnesium hydroxide slurry along with fatty acid (1 or 2 mole eq) and the mixture was stirred to melt and mix the reactants. The mixture was reacted overnight at 85° C. The fatty acid salts are insoluble in water and precipitated out as they were formed. Fatty acid salts were isolated from the reaction by filtration and washed with DI water until the filtrate had a TDS (total dissolved solids measured with an electrical conductivity meter) of <20 ppm. Isolated yield was >93% based on starting materials. The products are insoluble in Triacetin (TA) or PEG400, and the reaction itself cannot be performed in TA or PEG400 as solvents.

Thermogravimetric analysis (TGA) was used to compare relative thermal stability and volatility. Fatty acid salts were all solids and were pre-dried at 50° C. to remove excess moisture. The volatility of lauric acid alone was evident from TGA. Weight loss begins at about 150° C. with the onset identified as 209 in the TGA curve, and a peak or maximum rate of wt loss by about 245° C. In contrast, the Mg-fatty acid salts persist to over 300° C. Most of these preparations showed evidence of dehydration, as about 3% to 6% weight loss at temperatures between 80° C. and 110° C. However, the salts themselves are not volatile.

TABLE 1
TGA for thermal stability.

| | Signal at 300° C. |
|---|---|
| Material | (572° F.) |
| Lauric acid | 1.6% |
| Mg monolaurate | 91.3% |
| Mg dilaurate | 84.0% |
| Mg monopalmitate | 92.3% |
| Mg dipalmitate | 85.3% |
| Mg monostearate | 93.0% |
| Mg distearate | 83.7% |

Sodium and Calcium salts were made similarly from palmitic and stearic acid. Sodium hydroxide and Calcium hydroxide did not require an acid initiator to form insoluble salts from fatty acids in water.

### Example 2. Compression Molded Films from Dry Blends

Dry blends were made for compression molding according to Table 2. Plasticizer was added to the cellulose diacetate (CA398-30) powder along with any additives, and the blend was mixed in a coffee grinder. Each complete dry blend was pre-weighed (5.0 g) into aluminum pans and dried for 2 h at 60° C.

Films were pressed for a total of 4 minutes on a heated press with the upper and lower platens pre-heated to 425° F. (218° C.). The pre-dried CA/TA/additive dry blend was applied to the center of a 4-inch square, 10 mil thick frame between a top and bottom layer of aluminum foil, all between two steel plates. The assembly was placed in the press and heated for 1 min at 0 pressure to dry and pre-melt the powder, then pressed for 1 minute at 12,000 PHI, bumped up to higher pressure over ~30 seconds, and finally held for 2 minute at 20,000 PHI (Ram force in pounds).

With a low plasticizer content (10% Triacetin; TA), the melt flow at 218° C. is poor—insufficient to fully fill the frame during pressing. The addition of 2% to 5% of fatty acid salts of magnesium resulted in good flow, sufficient to fill the frame, and transparent or nearly transparent films. In contrast, very dark color formed during compression molding after including 2% of fatty acid salts of Sodium (Na), or else white color or inclusions were evident in pressed films with 2% Calcium stearate or Zinc stearate salts.

TABLE 2
Compression molded films made with CA398-30.

| FILM# | PZ (wt %) | Salt (wt %) | Pressed films |
|---|---|---|---|
| 1 | TA (10) | none | Poor flow, clear |
| 2 | TA (15) | Mg di-laurate (2) | Good flow, clear, low color |
| 3 | TA (15) | Mg di-palmitate (5) | Good flow, clear, low color |
| 4 | TA (15) | Mg mono-palmitate (5) | Good flow, clear, low color |
| 5 | TA (15) | Mg di-stearate (5) | Good flow, clear, low color |
| 6 | TA (15) | Mg mono-stearate (5) | Excellent flow, slight haze, low color |
| 7 | TA (10) | Na stearate (2) | Very dark color |
| 8 | TA (10) | Na palmitate (2) | Very dark color |
| 9 | TA (10) | Ca stearate (2) | White speckles, waxy |
| 10 | TA (10) | Zn stearate (2) | White, waxy |

### Example 3. Compounding on a Twin-Screw Extruder (with Stabilizers)

Formulations were made at a 1-lb scale, each containing 86% CA394-60S (ground); 10% Triacetin, 2% fatty acid salt according to Table 3, and 1% citric acid and 1% palmitic acid as stabilizers. Material was compounded on the Eurolab Prism Extruder with a general-purpose screw design. The screw diameter was 16 mm, L/D=40:1, with a screw length of 640 mm. The barrel temperature was set at 220° C. Analyses carried out on the pellets include Triacetin content and Melt Flow Index (MFI).

TABLE 3
Composition of formulations compounded on a TSE

| Material | | Measured Triacetin | MFI |
|---|---|---|---|
| # | Flow aid (2 wt %) | (wt %) | (g/10 min) |
| 11 | Sodium palmitate | Did not compound | |
| 12 | Sodium stearate | Did not compound | |
| 13 | Calcium stearate | Did not compound | |
| 14 | Zinc stearate | 5.0 | 9.18 |
| 15 | Mg stearate/palmitate | 4.8 | 2.82 |
| | (USP) | | |
| 16 | Mg distearate | 5.1 | 5.80 |
| 17 | Mg monostearate | 4.8 | 2.38 |
| 18 | Mg dipalmitate | 4.9 | 6.71 |
| 19 | Mg monopalmitate | 5.1 | 2.80 |
| 20 | Mg dilaurate | 5.0 | 4.71 |
| 21 | Mg monolaurate | 5.0 | 1.84 |

### Comparative Example 3a. Compounding without Stabilizers

Formulations were compounded on a lab-scale twin screw extruder according to Table 3a. CA394-60S was pre-ground. The pellets were dark brown and could not be pressed into films or injection molded as flex bars.

TABLE 3a
Composition and loading of compounded formulations.

| | Cellulose | | |
|---|---|---|---|
| | Acetate Resin | Plasticizer | |
| Material # | (wt %) | (wt %) | Flow Aid (wt %) |
| 22 | CA398-60S (88) | Triacetin (10) | Mg distearate |
| | | | Sigma cat# 415057 (2) |
| 23 | CA398-60S (88) | Triacetin (10) | Mg dipalmitate (2) |
| 24 | CA398-60S (88) | Triacetin (10) | Mg monopalmitate (2) |

### Example 4. Transparency of Pressed Films

Films were pressed from compounded pellets of Example 3. Films were pressed for a total of 4 minutes on a heated press (PHI) with the upper and lower platens pre-heated to 425° F. (218° C.). The pellets were applied to the center of a 4-inch square, 10 mil thick frame between a top and bottom layer of aluminum foil, all between two steel plates. The assembly was placed in the press and heated for 1 min at 0 pressure to dry and pre-melt the puck, then pressed for 1 minute at 12,000 PHI, bumped up to higher pressure over ~30 seconds, and finally held for 1.5 minute at 20,000 (Ram force in pounds). Haze and Clarity were measured using a Haze-gard instrument (BYK). Transparency was quantified as color difference, Delta E (CIE76). Transparency is taken as an indicator of compatibility (Table 4).

TABLE 4
Effect of flow Aid on film clarity.

| Material | | Haze-gard | | Delta E |
|---|---|---|---|---|
| # | Flow Aid (2 wt %) | Haze | Clarity | Transparency |
| 14 | Zinc stearate | 43.4 | 84.8 | 51.8 |
| 15 | Mg stearate/palmitate | 26.7 | 94.4 | 53.2 |
| | (USP) | | | |
| 16 | Mg distearate | 14.1 | 95.8 | 55.7 |
| 17 | Mg monostearate | 23.6 | 95.5 | 53.8 |
| 18 | Mg dipalmitate | 16.7 | 95.5 | 55.4 |
| 19 | Mg monopalmitate | 30.9 | 91.8 | 54.1 |
| 20 | Mg dilaurate | 25.6 | 94.3 | 54.2 |
| 21 | Mg monolaurate | 28.0 | 96.2 | 53.4 |

### Example 5. Compounding with Stabilizers on a Two-Roll Mill or Twin-Screw Extruder

Compositions in Table 5A were pre-blended at 200 g scale. CA394-60S was pre-ground. The blends were compounded on a lab-scale two-roll mill (TRM) with a residence time of up to 10 minutes. Back roll temperature: 205° C.; Front roll temperature: 215° C.; Roll gap: 20 microns.

The formulations in Table 5B. were compounded on a twin-screw-extruder (TSE), utilizing a high mixing screw with a 40 mm diameter, to form pellets. Melt temperature was set to 225 C. CA394-60S was pre-ground.

TABLE 5A
Compositions compounded on a two-roll mill.

| | Composition (TRM) | | | | | |
|---|---|---|---|---|---|---|
| | Resin | | Flow aid | | | |
| | CA394- | Plasticizer | Mg | | | |
| Material | 60S | Triacetin | stearate | Stabilizer(s) | | Compounding |
| # | (wt %) | (wt %) | (wt %) | (wt %) | Filler | on TRM |
| 25 | 88 | 10 | 2 | | | Did not |
| | | | | | | compound |
| 26 | 86 | 1 | 2 | citric acid (2) | | Clear sheet |
| | | | | | | from roll |
| 27 | 86 | 10 | 2 | citric acid (1) | | Clear sheet |
| | | | | lauric acid | | from roll |
| | | | | (1) | | |
| 28 | 86 | 10 | 2 | citric acid (1) | | Clear sheet |
| | | | | lauric acid | | from roll |
| | | | | (1) | | |
| 29 | 86 | 10 | 2 | citric acid (1) | | Clear sheet |
| | | | | palmitic acid | | from roll |
| | | | | (1) | | |
| 30 | 86 | 10 | 2 | citric acid (1) | Mg(OH)₂ | Translucent |
| | | | | lauric acid | (2) | sheet |
| | | | | (1) | | |
| 31 | 86 | 10 | 2 | citric acid (1) | Mg(OH)₂ | Translucent |
| | | | | palmitic acid | (2) | sheet |
| | | | | (1) | | |

TABLE 5B
Compositions compounded on a TSE.

| Material | | | | |
|---|---|---|---|---|
| # | Composition (TSE) | | | |
| 32 | CA394-60S | Triacetin | Mg Stearate | citric acid (2 wt %) |
| | (86 wt %) | (10 wt %) | (2 wt %) | |
| 33 | CA394-60S | Triacetin | Mg Stearate | citric acid (1 wt %) |
| | (86 wt %) | (10 wt %) | (2 wt %) | palmitic acid (1 wt %) |
| 34 | CA394-60S | Triacetin | Mg stearate | citric acid (1 wt %) |
| | (84 wt %) | (12 wt %) | (2 wt %) | palmitic acid (1 wt %) |

### Example 6. HDT at 100% RH to Compare Heated Dimensional Stability

The compounded pellets of Example 5 were injection molded as flex bars for Heat Deflection Temperature (HDT) according to ASTM D648. The low pressure (LPRS) HDT of flex bars was measured after equilibration at 20° C. and 50% RH and separately after 48 h equilibration at 20° C. and 100% RH.

TABLE 6
HDT of compounds (Temperatures in degrees Celsius)

| | HPRS, 50% | LPRS, 50% | LPRS, 100% |
|---|---|---|---|
| Material # | RH | RH | RH |
| 32 | 89.9 | 110.6 | 73.2 |
| 33 | 87.1 | 107.9 | 79.4 |
| 34 | 77.7 | 99.2 | 63.6 |

### Example 7. Batch Foaming

Two formulations (Table 7) were compounded on a twin-screw extruder, utilizing a high mixing screw with a 40 mm diameter, to form pellets. Melt temperature was set to 225° C. CA394-60S was ground.

TABLE 7

| Material # 35 | Material # 36 |
|---|---|
| CA394-60S (84 wt %) | CA394-60S (79 wt %) |
| Triacetin (12 wt %) | Triacetin (12 wt %) |
| Mg stearate (2 wt %) | Mg stearate (2 wt %) |
| citric acid (1 wt %) | citric acid (1 wt %) |
| palmitic acid (1 wt %) | palmitic acid (1 wt %) |
| | 5% kaolin (5 wt %) |

Films were pressed on a Carver Heated Press. Films were pressed for a total of 7 minutes with the upper and lower platens pre-heated to 428° F. (220° C.). The blends were applied to the center of a 4-inch square, 10 mil thick frame between a top and bottom layer of Kapton film, all between two pieces of Teflon. The assembly was placed in the press and heated for 5 min at 0 pressure to dry and pre-melt the material, then pressed for 1 minute at 10,000 PSI, bumped up to higher pressure over ~60 seconds, and finally held for 1 minute at 40,000 PSI.

Pressed films were subjected to batch foaming. Batch foaming was conducted in a 300-mL high-pressure autoclave (Parr Instrument Company Model No. 4561) with a diameter of 2.5 inches and a depth of 4 inches equipped with thermocouple. The dip tube, agitator shaft, and impeller were removed from the autoclave. In a typical experiment, three to four 10-mil thick films (1 inch×1 inch) were placed on custom-made trays (L x W x H, 1.5×1.5×0.5 inches). Each tray contained one film and the trays were stacked on top of each other inside the autoclave. The trays were made by folding Teflon-lined foil into the desired dimensions. The vessel was closed, tightly sealed, and then heated to the desired temperature, which may range from 150° C. to 230° C. After the desired temperature was reached, CO₂ gas was pumped into the vessel via the supply valve to the desired pressure (50-130 bar). The vessel was let to stabilize for 30 mins once it equilibrated at the set temperature to provide sufficient time for CO₂ gas penetration into the films. At the end of the dwell time, the pressure was quickly released to atmospheric pressure through a fully opened valve on a 0.25″ vent pipe while purging with air. The vessel was let to cool to room temperature and the foamed films were retrieved. The foamed film samples were placed in Ziploc bags and stored in a refrigerator until further testing was carried out.

### Example 8. Characterization of Batch Foamed Samples

Foamed samples from Example 7 were analyzed. Foam density was measured using an XSR analytical balance, fitted with a Mettler-Toledo density kit (model #30460852) was used to measure density of the batch foam samples. Place weigh basket onto density attachment and place the beaker on the base. Using DI water, fill provided beaker to fully cover weigh basket. Place provided thermometer on side of beaker. Allow water to adjust to room temperature before use (around 10 minutes). Kit enables density measurements of solid, liquid, porous, and floating samples. Foam is cut from the sheet using a 22 mm circular punch. The foam piece is weighed first in air (on pan atop the kit), then submerged in water (held in place by the basket). The balance uses this information to calculate density. Five replicates were analyzed per sample and average density calculated.

Cells were uniform and uniformly distributed. The average pore size was measured from an SEM (scanning electron microscopy) image. The pore size distribution calculation is accomplished by first manually tracing the outline of a pore on an SEM image of a foam sample, using the computer mouse. Typically, 10 representative pores are selected to trace in an image. Once the manually tracing step is complete, the rest is handled by an image processing algorithm that processes the traces. The maximum diameter of the trace is determined by the algorithm in pixels. The scale bar in the image is then used to convert the pixel diameter to a real-world diameter in microns. The diameters are then averaged for each image & reported in Table 8.

TABLE 8

| | | Avg. pore |
|---|---|---|
| | Density | size |
| Sample Description | g/cc | (μm) |
| Material #35 (Mg-stearate) | 0.219 | 37 |
| Material #36 (Mg-stearate + | 0.291 | 50 |
| kaolin(5 wt %)) | | |

### Example 9. Sheet Extrusion (1.5 Inch Killion) 10 wt % Vs 12 wt % TA

20 mil thick sheet was melt extruded from Material #33 and #37. The 1.5-inch diameter extruder feeds a 12-inch-wide die. The film extruded from the formulation #33 containing 10% triacetin did not process very well and the film was hazy and very brittle. However, the film extruded from the formulation containing 12% triacetin processed much better and the film was more transparent.

TABLE 9

| Material # 33 | Material # 37 |
|---|---|
| CA394-60S (86 wt %) | 84% CA394-60S |
| | (84 wt %) |
| Triacetin (10 wt %) | Triacetin (12 wt %) |
| Mg stearate (2 wt %) | Mg stearate (2 wt %) |
| citric acid (1 wt %) | citric acid (1 wt %) |
| palmitic acid (1 wt %) | palmitic acid (1 wt %) |

### Example 10. Compounding and Foam Extrusion

Formulations were compounded on a twin-screw-extruder (TSE), utilizing a high mixing screw with a 40 mm diameter, to form pellets. Melt temperature was set to 225° C. CA394-60S was pre-ground. The composition of the compounded pellets was as follows:
86 wt % Eastman CA-398-30 or CA-394-60S
12 wt % Triacetin (plasticizer)
2 wt % Magnesium stearate (flow aid)
1 wt % Citric acid (stabilizing additive)
1 wt % Palmitic acid (stabilizing additive)

The CA resin powder was bag-blended with the solid white powder additives and fed through the main feeder, while the liquid plasticizer was fed using a liquid injector into Zone 2 of the extruder barrel. The compounded strands were run through a water trough and pelletized using a ConAir pelletizer. Representative twin-screw extrusion conditions are detailed below in Table 10A. The extruded pellets were then used for foam sheet extrusion and subsequent analyses and prototype thermoforming.

TABLE 10A
Compounding twin-screw extruder conditions.

| Load / Torque % | 55 | |
|---|---|---|
| Screw RPM | 250 | |
| Melt Temperature (° C.) | 205 | |
| Melt Pressure (psi) | 68 | |
| Die Type / Inj. Size | 5-hole | |
| Sample Size (lbs) | 200 | |
| | Set | Actual |
| Barrel Temperature | (° C.) | (° C.) |
| Zone 1 | 60 | 61 |
| Zone 2 | 90 | 94 |
| Zone 3 | 140 | 140 |
| Zone 4 | 200 | 200 |
| Zone 5 | 220 | 220 |
| Zone 6 | 220 | 220 |
| Zone 7 | 220 | 218 |
| Zone 8 | 220 | 219 |
| Zone 9 | 220 | 216 |
| Die 1 | | |
| Die 2 | | |
| | Rate | Percent |
| Feeder 1 (powder blend) | 113 | 88 |
| Feeder 2 (liquid) | 16 | 12 |

The pellets formed thereby were then pre-dried overnight at 60° C. prior to foam sheet extrusion. Foam extrusion was performed on a 1.5-inch Killion sheet extruder equipped with a Maddock mixing screw and an adjustable sheet/film flat die. The dried compounded pellets were bag-blended with a chemical blowing agent (Foamazol 73S sold by Bergen International), also in pellet form, at a concentration of 1 wt % and fed to the extruder through the main feeder. Representative foam sheet extrusion conditions are detailed below in Table 10B. The foam sheet was extruded at a thickness of 40 mils (~1 mm) and its bulk density was measured to be 0.643 g/cm³, using the procedure described in Example 8, and thereby categorized as a “medium-density” foam sheet. The cellular morphology of the foam sheet was characterized using scanning electron microscopy (SEM) as described in Example 8. The average pore size was measured to be 227 microns. In general, the cells in the transverse direction appeared to be of varying sizes and of random form. Several of the foam cells also appeared to have coalesced with adjacent cells to form larger cells.

TABLE 10B
Foam sheet extrusion conditions.

| Screw Type | Maddock |
|---|---|
| Screw RPM | 67 |
| Amps | 5 |
| Blowing Agent Type | Foamazol 73S |
| Blowing Agent Concentration (wt %) | 1 |
| Drying Temperature (° C.) | 60 |
| Drying Time (hours) | 6-8 |

Melt Pressure (psi)

| | |
|---|---|
| Pressure Zone 1 | 320 |
| Pressure Zone 2 | N/A |
| Pressure Zone 3 | 502 |

Barrel Temperature (° C.)

| | |
|---|---|
| Zone 1 | 210 |
| Zone 2 | 216 |
| Zone 3 | 216 |
| Clamp Ring | 216 |
| Adaptor | 216 |

Die Temperature (° C.)

| | |
|---|---|
| Zone 1 | 232 |
| Zone 2 | 227 |
| Zone 3 | 232 |

Melt Temperature (° C.)

| | |
|---|---|
| Melt Zone 1 | 186 |
| Melt Zone 2 | 231 |
| Melt Zone 3 | 218 |

Casting Roll Stack

| | |
|---|---|
| Top Roll Temperature (° C.) | 93 |
| Bottom Roll Temperature (° C.) | 96 |
| Speed (ft/min) | 5.4 |

### Example 11. Cobb Test Analysis to Measure Water and Oil Absorption of Foam Sheet

The quantity of water and oil absorbed by the foam sheet sample extruded in Example 10, i.e., water and oil absorptiveness, was characterized by performing a Cobb test. This test was modeled on ISO535: 2014 (E) “Paper and board-Determination of water absorptiveness-Cobb method”. A circular specimen of diameter 6 cm was cut from the foam sheet and its weight recorded (pre-weight). It was then mounted in the test apparatus and secured to form a leakproof seal. Tap water at room temperature was filled in the test cup and the sample was held for 30 minutes. Then, the sample was carefully removed from the cup, excess water was blotted off and the sample was re-weighted (post-weight). The difference in the post- and pre-weights was normalized with the specimen surface area to obtain water absorptiveness value in g cm⁻². The same procedure was followed with oil instead of water to obtain oil absorptiveness value. The extruded foam sheet of Example 10 of the composition described in the present invention was measured to have a water and oil absorptiveness values of 14 g cm⁻² and 24 g cm⁻², respectively.

### Example 12. Modulus Measurement of Foam Sheet at High Temperature and Humidity Conditions

Dynamic Mechanical Analysis (DMA) was performed at high temperature and relative humidity (RH) conditions to determine the degree of stiffness or modulus loss of the foam sheets extruded in Example 10. The instrument used was a TA Instruments DMA Q850 fitted with a film tension clamp and a RH control unit. A test specimen of thickness 1.12 mm was cut to a fixed width of 6.35 mm. The effective length of the specimen was measured after sample loading to be 10.74 mm. Initially, at a controlled force of 0 N, so as to not stress/strain the sample, the temperature and RH were equilibrated for 240 minutes at 80° C. and 0% respectively. After equilibration, an oscillation measurement at a strain level of 0.1% and frequency of 1 Hz was carried out. The same process was performed at a RH of 60% as well. The modulus data was recorded and compared for both the RH levels tested. The foam sample extruded in Example 10 of the composition described in the present invention exhibited a 27% loss in modulus as RH was increased from 0 to 60%.

### Example 13. Melt-Flow Rheological and MFI Evaluation of Compounds with and without a Flow Aid Additive

The small amplitude oscillatory shear (SAOS) melt-flow rheological properties of the composition described in the present invention were measured and compared with compounds prepared without any flow aid additive and varying concentrations of triacetin plasticizer. The test was carried out on a TA Instruments ARES-G2 rotational rheometer using 25 mm stainless steel parallel plate geometry. The samples used for the test were in the form of pellets. Using a constant strain setting of 0.1%, a frequency sweep from 1 to 100 rad/s was performed at 5° C. step increments between 200° C. and 230° C. The sample melt was allowed to soak and equilibrate at each temperature for 90 seconds. The frequency sweep data obtained at different temperatures were shifted following time-temperature superposition (TTS) principles to a reference temperature (T_{ref}) of 230° C., and a master curve of complex viscosity (η*, Pa-s) versus angular frequency (ω, rad/s) was constructed. The angular frequency axis of the master curve (ω) was subsequently transformed to shear rate (\dot{γ}, 1/s), using the Cox-Merz principle. The η* versus \dot{γ} master curve was thereby fit to the Cross model equation to obtain the zero-shear viscosity (η₀, Pa-s), which has been listed for all the compounds of this example in Table 13.

The melt flowability of the composition described in the present invention was also characterized using melt-flow index (MFI) testing and compared with compounds prepared without any flow aid additive and varying concentrations of plasticizer. MFI tests were carried out according to ASTM D1238 at 240° C. and using a load weight of 2.16 kg and 5 kg. Table 13 also lists the MFI values in g/10 mins for all the compounds of this example. As evidenced from Table 13, η₀ increases and MFI decreases as the concentration of plasticizer is reduced. However, the addition of a flow aid to a low plasticizer compound results in a decrease in η₀ and an increase in MFI, thereby demonstrating the effectiveness of a flow aid additive in increasing the melt flowability of a cellulose ester-based compound.

TABLE 13
Melt flow properties of compounds with and without a flow aid additive.

| | Zero-shear | | |
|---|---|---|---|
| | viscosity (η₀) | | |
| Sample | (Pa-s) | | |
| Composition | (Obtained | Melt-Flow Index | Melt-Flow Index |
| (All samples use | from SAOS | (MFI) (g/10 min) | (MFI) (g/10 min) |
| Eastman CA398-30 | TTS analysis | (Obtained at T = | (Obtained at T = |
| or CA394-60S as | at T_{ref} = | 240° C. and 2.16 | 240° C. and 5 kg |
| base resin) | 230° C.) | kg load) | load) |
| 20 wt % Triacetin | 3458 | 12.6 | 32.5 |
| (plasticizer) | | | |
| 15 wt % Triacetin | 5813 | 6.9 | 22.4 |
| (plasticizer) | | | |
| 12 wt % Triacetin | 14381 | 5.2 | 9.05 |
| (plasticizer) | | | |
| 12 wt % Triacetin | 3413 | 7.4 | 45.1 |
| (plasticizer) + 2 wt % | | | |
| Magnesium stearate | | | |
| (Flow aid) + 1 wt % | | | |
| citric acid (stabilizer) + | | | |
| 1 wt % palmitic acid | | | |
| (stabilizer) | | | |

### Example 14. Industrial and Home Compostability Testing of Foamed Sheet Samples Made with and without a Flow Aid Additive

% disintegration of the foam sheet extruded in Example 10 was characterized in industrial (IC) and home compost (HC) environments, following ISO20200 method. The synthetic compost mixture for both tests was prepared within the framework laid out in the standard test method. The compost mixture was divided into two reactor boxes and the test samples were placed in them. The foam samples used were 1″×1″ square specimens amounting to ~0.5 wt % of a 1000 g synthetic compost mixture. The industrial compost test was run for a total of 12 weeks, while the home compost test was run for 26 weeks. The mixing and % moisture adjustment protocol for the IC and HC compost mixtures were followed as outlined under ISO20200 method. At the end of both the IC and HC tests, the compost was sieved, remaining samples retrieved, dried and documented for determining % disintegration. Table 14 describes the disintegration performance of the test foam samples in IC and HC tests. The foam sample of the composition described in the present invention which comprises a flow aid exhibited a higher level of disintegration compared to a control sample without any flow aid, in both IC and HC tests.

TABLE 14
Disintegration of foam samples in ISO20200
industrial and home composting tests.

| | Industrial Composting Test | | Home Composting Tests (26 | |
|---|---|---|---|---|
| | (12 weeks) | | weeks) | |
| | | 12 wt % Triacetin | | 12 wt % Triacetin |
| | | (plasticizer) + | | (plasticizer) + |
| | | 2 wt % | | 2 wt % |
| | | Magnesium | | Magnesium |
| | | stearate (flow | | stearate (flow |
| | | aid) + 1 wt % | | aid) + 1 wt % |
| | 20 wt % | citric acid | 20 wt % | citric acid |
| | Triacetin | (stabilizer) + | Triacetin | (stabilizer) + |
| | (plasticizer) | 1 wt % palmitic | (plasticizer) | 1 wt % palmitic |
| | (Control) | acid (stabilizer) | (Control) | acid (stabilizer) |
| % | 56 | 63 | 67 | 88 |
| Disintegration | | | | |

### CLAIMS NOT LIMITED TO DISCLOSED EMBODIMENTS

The preferred forms of the invention described above are to be used as illustration only and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

1. A composition comprising:
a) a cellulose ester;
b) a plasticizer; and
c) a flow aid comprising a salt having a melting point of 100° C. to 250° C.,

2. The composition of claim 1, wherein the composition further comprises a carboxylic acid stabilizer.

3. The composition of claim 2, wherein the carboxylic acid stabilizer is citric acid, succinic acid, adipic acid, fumaric acid, maleic acid, malic acid, lauric acid, oxalic acid, myristic acid, oleic acid, palmitic acid, stearic acid, or combinations thereof.

4. The composition of claim 2, wherein the carboxylic acid stabilizer is citric acid.

5. The composition of claim 2, wherein the carboxylic acid stabilizer is present at from 0.1 to 10 wt %, based on the total weight of the composition.

6. The composition of claim 1, wherein the flow aid comprises a blend of saturated or unsaturated (C₈₋₂₈) fatty acid salts.

7. The composition of claim 1, wherein the flow aid comprises a saturated or unsaturated (C₈₋₂₈) fatty acid salt.

8. The composition of claim 1, wherein the salt comprises a cation selected from the group consisting of ammonium, imidazolium, pyridinium, pyrrolidinium, triazolium, phosphonium, piperidinium, morpholinium, tetrazolium, pyrazolium, sulfonium, and thiazolium ions.

9. The composition of claim 1, wherein the salt comprises a cation selected from the group consisting of Group 1 or Group 12 metal ions.

10. The composition of claim 9, wherein the metal is selected from the group consisting of magnesium, aluminium, calcium, potassium, sodium, and zinc.

11. The composition of claim 10, wherein the metal is magnesium.

12. The composition of claim 1, wherein the flow aid is magnesium stearate or magnesium palmitate.

13. The composition of claim 1, wherein the flow aid is present at greater than 0.1 wt %, based on the total weight of the composition.

14. The composition of claim 1, wherein the cellulose ester has a degree of substitution for hydroxyl substituents in the range of from 0.4 to 0.9.

15. The composition of claim 1, wherein the cellulose ester is a cellulose acetate, a cellulose acetate propionate, or a cellulose acetate butyrate.

16. The composition of claim 1, wherein the cellulose ester is present at from 50 to 98.7 wt %, based on the total weight of the composition.

17. The composition of claim 1, wherein the plasticizer comprises glycerol triacetate (Triacetin), glycerol diacetate (Diacetin), dibutyl terephthalate, dimethyl phthalate, diethyl phthalate, poly(ethylene glycol) MW 200-600, dibutyl tartrate, di-2-methoxyethyl phthalate, ethyl o-benzoylbenzoate, triethylene glycol dipropionate, 1,2-epoxypropylphenyl ethylene glycol, 1,2-epoxypropyl(m-cresyl)ethylene glycol, 1,2-epoxypropyl(o-cresyl)ethylene glycol, β-oxyethyl cyclohexenecarboxylate, bis(cyclohexanate) diethylene glycol, triethyl citrate, polyethylene glycol, propylene glycol, polysorbate, sucrose octaacetate, acetylated triethyl citrate, acetyl tributyl citrate, Admex, tripropionin, Scandiflex, poloxamer copolymers, polyethylene glycol succinate, diisobutyl adipate, polyvinyl pyrollidone, and glycol tribenzoate, the benzoate containing plasticizers such as the Benzoflex™ plasticizer series, poly (alkyl succinates) such as poly (butyl succinate), polyethersulfones, o-Cresyl p-toluenesulfonate, n-ethyltoluenesulfonamides, adipate based plasticizers, soybean oil epoxides such as the Paraplex™ plasticizer series, sucrose based plasticizers, dibutyl sebacate, tributyrin, sucrose acetate isobutyrate, the Resolflex™ series of plasticizers, triphenyl phosphate (TPP), triethyl phosphate (TEP), glycolates (e.g., ethyl phthalyl ethyl glycolate “EPEG” and methyl phthalyl ethyl glycolate “MPEG”), methoxy polyethylene glycol, 2,2,4-trimethylpentane-1,3-diyl bis(2-methylpropanoate), or polycaprolactones.

18. The composition of claim 1, wherein the plasticizer is a food-compliant plasticizer.

19. The composition of claim 1, wherein the plasticizer is present at from 1 to 20 wt %, based on the total weight of the composition.

20. A composition comprising:
a) 73 to 94.7 wt % of a cellulose acetate;
b) 5 to 20 wt % of triacetin;
c) 0.5 to 5 wt % of a magnesium palmitate or magnesium stearate; and
d) 0.2 to 2 wt % of citric acid,
all based on the total weight of the composition.

21. An article comprising the composition of claim 1.

22. The article of claim 21, wherein the article is a foam, a pellet, a granule, a powder, a sheet, or a film.

23. An article comprising a composition comprising:
a) 73 to 94.7 wt % of a cellulose acetate;
b) 5 to 20 wt % of triacetin;
c) 0.5 to 5 wt % of a magnesium palmitate or magnesium stearate; and
d) 0.2 to 2 wt % of citric acid,
all based on the total weight of the composition.

24. The composition of claim 1, wherein the composition has a heat deflection temperature of greater than 50° C. when tested under low pressure at 100% relative humidity (RH) according to ASTM D648 or ISO 75.

25. The composition or article of claim 1, wherein the composition further comprises one or more physical blowing agents, chemical blowing agents, mineral fillers, alkaline, pigments, secondary plasticizers, and/or natural fillers.

26. The article of claim 21, wherein when the article is a 25.4 mm×25.4 mm×1 mm foam with a density of 0.643 g/cm³, the article exhibits at least 50% disintegration under the ISO20200 standard in industrial or home composting test conditions.
